(19) United States
(12) Patent Application Publication
(10) Pub. No.: US 2014/0366888 A1
(43) Pub. Date: Dec. 18, 2014

(54) Bathroom Laptop Device

(71) Applicant: Larry O. Phlegar, Hampton, VA (US)

(72) Inventor: Larry O. Phlegar, Hampton, VA (US)

(21) Appl. No.: 13/917,283

(22) Filed: Jun. 13, 2013

(51) Int. Cl. A61G 5/14

(52) U.S. Cl. CPC A61G 5/14; A61G 2200/34
USPC 128/845

(57) ABSTRACT

A device for assisting with bowel movements. The device comprises a rectangular, generally flat portion. The device has rounded ends with hand-holds so that the user may grip the device for stability and leverage. The device is semi-rigid, and preferentially formed from a plastic or other impervious material.

### BACKGROUND OF THE INVENTION

The present invention relates to personal care devices and, more specifically, to devices intended to assist users with bowel movements.

Many individuals struggle with weight issues, particularly as they age. Often, infirmities associated with age or injuries make it difficult or impossible for an individual to effectively control their weight. One of the results of this problem is difficulty in taking care of personal needs, such as bowel movements. Often, when seated on a toilet an elderly or heavyset person, or a person with other medical conditions, may have difficulty in moving their bowels and require some assistance. The person may need to strain and/or use additional muscles to provide the leverage necessary to have a successful bowel movement.

In addition, for the heavyset person, their stomach may protrude forward in a manner that interferes with their ability to properly and completely evacuate their bowels. This impediment, in combination with other medical problems but with the complicating issue of having to strain to evacuate their bowels, places individuals at risk of injury from overstrain and the like.

There are prior inventions that teach mechanical devices to assist individuals with bowel movements. For example, U.S. Pat. Pub. No. 2011/0099681 by Imai et al. for METHOD AND APPARATUS FOR ENHANCED ERGONOMIC BOWEL MOVEMENT POSTURE, published May 5, 2011 teaches a device, worn as a vest, to assist individuals while utilizing public toilets for bowel movements. U.S. Pat. No. 4,051,560 by Audet for BOWEL MOVEMENT ENERGIZER SYSTEM, issued Oct. 4, 1977, teaches a device that may be attached to toilet seat and may be operated to assist a person in having a bowel movement through a “lateral rocking movement”. Other inventions are more invasive, such as that taught by U.S. Pat. No. 6,026,326 by Bardy for APPARATUS AND METHOD FOR TREATING CHRONIC CONSTIPATION, issued Feb. 15, 2000. The Bardy invention teaches an apparatus that utilizes electrical stimulators implanted in the user's body.

What is needed is an economical and uncomplicated device and method that can be utilized by those with constipation problems. Such a device and method should provide support for the abdominal area of an overweight user.

It is also desirable that such a device and method to provide the user with a stable but portable surface and means for gaining leverage in order to assist with bowel movements.

It is further desirable that such a device be simple and easy to use for an average user or, more critically, an elderly person.

### SUMMARY OF THE INVENTION

The present invention is directed to a new and improved invention related to assisting an end user while having a bowel movement. It is a further object of the present invention to is provide a new and improved device to provide support for an individual while evacuating their bowels, as well as providing a stable surface from which to gain leverage while having a bowel movement.

It is a further object of the present invention to provide a device to assist an end user while having a bowel movement, the device being simple and portable, as well as being easily carried and utilized by the elderly and by those with medical problems or disabilities.

### DESCRIPTION OF THE DRAWINGS

FIG. 1 is a view of an embodiment of the present invention.

FIG. 2 is a view of an embodiment of the present invention being utilized by an individual.

### DESCRIPTION OF A PREFERRED EMBODIMENT

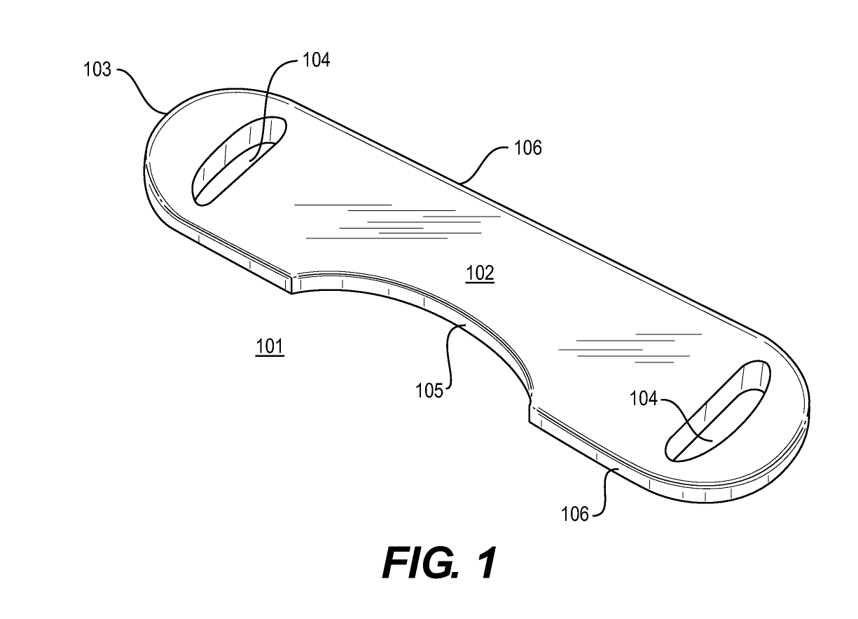

Referring now to FIG. 1, an embodiment of the current invention is shown. FIG. 1 shows the device 101 with a center portion 102, the center portion 102 comprised of a generally rectangular form. The device has two long edges 106, and the two ends 103 of the device 101 are rounded, with hand holds 104 through each of the ends 103. All of the edges of the invention may preferably be rounded so as to avoid causing hard to a user. The device 101 further comprises a rounded concave portion 105. When in use, the concave portion 105 is position against a user's abdomen. The device is preferentially comprised of material of thickness sufficient to provide semi-rigidity. When utilizing plastics, that thickness will generally be no greater than one half inch, but it will be understood that various thicknesses of material may be used without deviating from the scope of the invention.

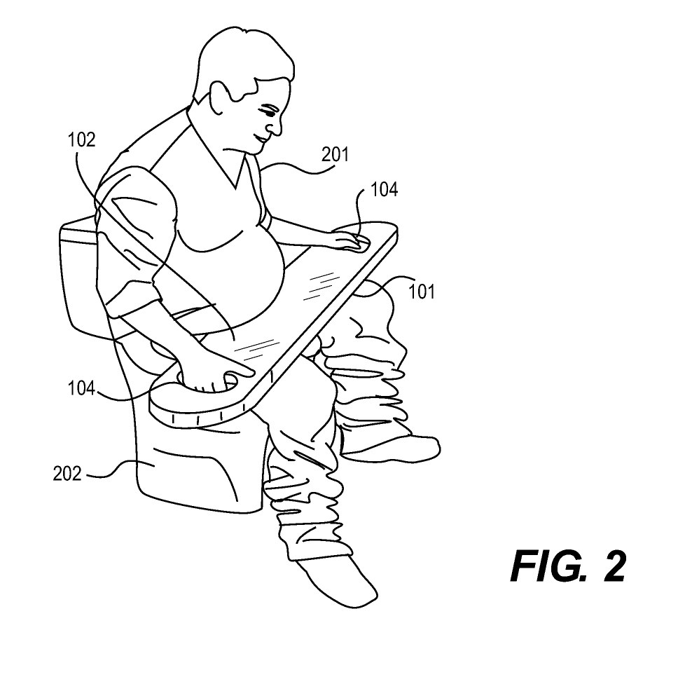

Referring now to FIG. 2, the device 101 is being shown in use. The user 201 is in a seated position on a toilet 202. The device 101 is position against the user's waist, horizontally across the user's lap. The device 101 is gripped by the user at the hand holds 104, with the center portion 102 positioned under the user's abdomen, with the abdomen resting on the center portion 102.

In this position, the user may utilize the device to provide leverage in assisting in difficult bowel movements.

The device is preferentially formed from a semi-rigid material that has anti-bacterial properties, such as Teflon or other impervious plastic and/or polymer compounds. It will be understood that wood and other materials may also be used, although when utilizing such other materials, the device will preferably be sealed, such as with a polymer or the like, in order to protect the device and to avoid the possibility of bacterial or other contamination.

It will be understood that, while the invention is described in detail herein, embodiments exist which are not described herein but which are covered by and fall within the spirit and the scope of the invention as described. It will also be understood that the present invention may be utilized for purposes not specifically described herein, but which utilize the inherent functionality of the device.

What is claimed:

1. A device comprising:
a center portion,
two long edges,
two end portions, and
two hand holds positioned one each in each of the end portions.

2. The device of claim 1, the device further comprising a concave portion along one long edge of the center portion.

3. The device of claim 1, wherein the device is comprised of semi-rigid material.

4. The device of claim 3, wherein the semi-rigid material is chosen from the group of bacterial-resistant materials.

5. The device of claim 4 wherein the group of bacterial-resistant materials includes plastics and other polymers.

6. A device for assisting with bowel movements, the device comprising:
a center portion,
two long edges,
two end portions, and
two hand holds positioned one each in each of the end portions,
the device further comprising a concave portion along one long edge of the center portion, the device is comprised of semi-rigid material chosen from the group of bacterial-resistant materials and where the group of bacterial-resistant materials includes plastics and other polymers.
